(19) United States
(12) Patent Application Publication
(10) Pub. No.: US 2011/0227339 A1
(43) Pub. Date: Sep. 22, 2011

(54) Biomass Fueled Combined Heat and Power Generator

(76) Inventor: Daniel Jean Rissacher, (US)

(21) Appl. No.: 12/726,303

(22) Filed: Mar. 17, 2010

(51) Int. Cl. F01B 23/10; F01K 7/16; F02G 3/00; F01K 17/02

(52) U.S. Cl. 290/2; 60/670; 60/39.6

(57) ABSTRACT

A small (0.1 kW to 1000 kW) biomass fired electrical generator consisting of a boiler or furnace designed to burn biomass material, a thermal to mechanical energy converter and a mechanical to electrical energy converter.

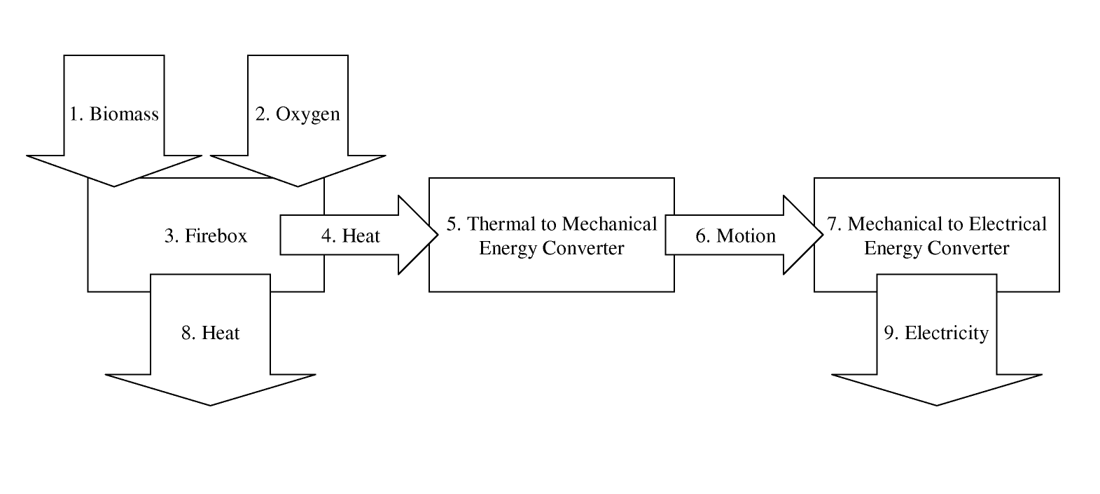

### BACKGROUND OF THE INVENTION

The apparatus of this invention resides in the area of electrical power and heat generation particularly applying biomass as a fuel source.

Previous use of biomass as a heat source using a boiler or furnace has been well established. Additionally, conversion of heat generated by various fuels into electrical energy comprises a large field of innovation. The current invention combines these technologies to provide a source of both electricity and heat using biomass fuel.

### SUMMARY OF THE INVENTION

The object of this invention is to produce both electrical and heat energy from the burning of biomass fuels particularly for small (0.1 kW to 1000 kW) electrical applications.

Biomass (wood, grass, corn, hay or other biological materials with varying amounts of processing) is combined with oxygen in a firebox and burned at a controlled rate to generate heat. This heat is then gathered and used to drive a thermal energy to mechanical energy converter. The medium used to forward this thermal energy can either be air in the case of a furnace, or liquid in the case of a boiler.

A thermal energy to mechanical energy converter takes heat as an input and produces mechanical force as an output. This converter can consist of a steam engine (piston, turbine, etc.) in the case of a liquid thermal medium, or an external combustion engine in the case of air as a thermal medium.

The mechanical force produced is then used to drive a mechanical energy to electrical energy converter. This generator head takes the motion produced as an input and produces electrical power as an output.

Therefore, the overall system takes biomass and oxygen as inputs and produces electricity and heat as outputs.

### BRIEF DESCRIPTION OF THE DRAWINGS

The FIGURE is a flow chart showing the physical components of the system and the medium/energy that flows between these components.

### DETAILED DESCRIPTION OF THE DRAWINGS

Biomass (1) is combined with Oxygen (2) burned in a firebox (3) to generate heat (4 & 8). This heat (4) is then passed to a device to convert the thermal energy into mechanical energy (5). The motion resulting (6) is then used to drive a device that converts mechanical energy into electrical power (7). Thus, the inputs to the system are Biomass (1) and Oxygen (2) and the outputs are Heat (8) and Electricity (9).

I claim:

1. An electrical generator powered by burning biomass.

2. The biomass burning electrical generator of claim 1, further consisting of a device designed for the controlled burning of biomass materials to include any living or recently dead biological materials including, but not limited to: wood, corn, grass or hay, in processed or unprocessed forms.

3. The biomass burning electrical generator of claim 1, further consisting of a boiler to gather heat energy generated by the burning biomass and transfer it, using a liquid medium, to a device which converts heat to mechanical energy.

4. The biomass burning electrical generator of claim 1, further consisting of a furnace to gather heat energy generated by the burning biomass and transfer it, using a gaseous medium, to a device which converts heat to mechanical energy.

5. The biomass burning electrical generator of claim 1, further consisting of a device to convert heat energy, stored in a liquid medium, into mechanical energy using a steam turbine and/or a steam piston engine.

6. The biomass burning electrical generator of claim 1, further consisting of a device to convert heat energy, stored in a gaseous medium, into mechanical energy using an external combustion engine.

7. The biomass burning electrical generator of claim 1, further consisting of a device to convert the mechanical energy into electrical power in the form of direct or alternating current.

8. The biomass burning electrical generator of claim 1, further serving a dual-role as a heating source.
